(19) United States
(12) Patent Application Publication
(10) Pub. No.: US 2007/0192421 A1
(43) Pub. Date: Aug. 16, 2007

(54) Image processing apparatus, mail processing method and mail processing program

(75) Inventor: Toshimichi Iwai, Kitakatsuragi-gun (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/635,651

(22) Filed: Dec. 8, 2006

(30) Foreign Application Priority Data
Feb. 2, 2006 (JP) 2006-025974

(51) Int. Cl. G06F 15/16

(52) U.S. Cl. 709/206

(57) ABSTRACT

An image processing apparatus comprising: a judgment unit for judging whether or not an e-mail received via a network is an e-mail delivered according to a mailing list or an e-mail forwarded after once delivered according to a mailing list; a recording unit; and a control unit for generating a BOX storing the e-mail as associated with the mailing list in said recording unit and storing the e-mail in said BOX if the received e-mail is judged to be an e-mail delivered according to a mailing list or an e-mail forwarded after once delivered according to a mailing list by said judgment unit.

The present application claims priority under 35 U.S.C. §119 to Japanese Unexamined Patent Application No. 2006-25974 filed on Feb. 2, 2006, and the disclosure is hereby incorporated by reference herein in its entirety.

### BACKGROUND OF THE INVENTION

1 . Field of the Invention

The present invention relates to an image processing apparatus for use in an multifunctional digital image forming apparatus such as a MFP (Multi Function Peripheral), a mail processing method for use in the apparatus, and a mail processing program stored on computer readable medium for making a computer in the apparatus execute mail processing.

2. Description of the Related Art

The following description sets forth the inventor's knowledge of related art and problems therein and should not be construed as an admission of knowledge in the prior art.

Multi-user terminals, such as personal computers, and MFP has been increasingly used as connected to each other via a network in companies and offices, and the MFP is used commonly by multiple users.

Meanwhile, a method using mailing list is a heretofore known art as a method to exchange e-mails among relatively large number of members. In the method, an originator sends an e-mail to a mailing list server, then the e-mail can be delivered to a plurality of members who are registered in the mailing list server (e.g., Japanese Unexamined Laid-open Patent Publication No. 2004-253870).

In recent years, members of mailing list more frequently exchange e-mails and attached files based on mailing list to improve job efficiency and business productivity.

There is an additional service to the conventional method of delivering using a mailing list, and the service enables a member who newly joined the mailing list to access or review the e-mails that have been distributed before his/her join to the mailing list. However, in cases without the service, the conventional method is still inconvenient for such a new member. That is, he/she cannot review the e-mails of the past because there is no e-mail stored for himself/herself, while existing members of the mailing list can access and review the e-mails of the past, which are stored in their own terminals.

In addition, the existing members also had a problem that accumulation of e-mails lead to larger consumption of the memory capacity of the recording unit (e.g., hard disk) in the respective terminals and the mail server.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

An object of the present invention is to provide an image processing apparatus, which enables not only a member who newly joined a mailing list, to review easily the e-mails that have been delivered before his/her join, but also all members to get relief from inconveniences caused by the limited storage capacity of their respective terminals and the mail server.

Another object of the present invention is to provide a mail processing method for use in the apparatus.

Yet another object of the present invention is to provide a mail processing program stored on computer readable medium for making a computer in said apparatus execute mail processing.

According to a first aspect of the preferred embodiment of the present invention, an image processing apparatus comprising:
a judgment unit for judging whether or not an e-mail received via a network is an e-mail delivered according to a mailing list or an e-mail forwarded after once delivered according to a mailing list;
a recording unit; and
a control unit for generating a BOX storing the e-mail as associated with the mailing list in said recording unit and storing the e-mail in said BOX if the received e-mail is judged to be an e-mail delivered according to a mailing list or an e-mail forwarded after once delivered according to a mailing list by said judgment unit.

According to a second aspect of the preferred embodiment of the present invention, a mail processing method for an image processing apparatus capable of receiving e-mails, comprising the steps of:
j judging whether or not an e-mail received via a network is an e-mail delivered according to a mailing list or an e-mail forwarded after once delivered according to a mailing list;
generating a BOX storing the e-mail as associated with the mailing list in a recording unit if the received e-mail is judged to be an e-mail delivered according to a mailing list or an e-mail forwarded after once delivered according to a mailing list in the judgment step;
storing the e-mail in the generated BOX.

According to a third aspect of the preferred embodiment of the present invention, a mail processing program for making a computer in an image processing apparatus capable of receiving e-mails execute mail processing, comprising the steps of:
judging whether or not an e-mail received via a network is an e-mail delivered according to a mailing list or an e-mail forwarded after once delivered according to a mailing list;
generating a BOX storing the e-mail as associated with the mailing list in a recording unit if the received e-mail is judged to be an e-mail delivered according to a mailing list or an e-mail forwarded after once delivered according to a mailing list in the judgment step; and
storing the e-mail in the generated BOX.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims

### BRIEF DESCRIPTION OF THE DRAWINGS

The preferred embodiments of the present invention are shown by way of example, and not limitation, in the accompanying figures, in which:

FIG. 1 is a schematic diagram showing a configuration of a mail delivery system using an image processing apparatus as one embodiment of the present invention.

FIG. 2 is a block diagram showing a functional configuration of the relevant part of a MFP, as an image processing apparatus.

FIG. 3 is a diagram for explaining mail-delivering operation in the mail delivery system shown in FIG. 1.

FIG. 4 is a diagram showing an example of text of an e-mail delivered using a mailing list to respective member terminals.

FIG. 5 is a diagram showing an example of text of an e-mail forwarded to a MFP from a user terminal.

FIG. 6 is a table showing a list of the members in the mailing list who are permitted to access to the respective BOXes in a BOX administration table;

FIG. 7 is a table showing the login accounts in the login account administration table;

FIG. 8 is a diagram showing a directory tree for administering holders by BOX.

FIG. 9 is a screen displaying a list of the mailing list BOXes stored in the MFP by the web browser of user terminal;

FIG. 10 is a screen jumped from the screen shown in FIG. 9 for inputting the login name and the account name;

FIG. 11 is a screen showing a list of descriptions in a BOX associated with the mailing list; and

FIG. 12 is a flowchart showing a process executed in an MFP when an e-mail is received.

### DETAILED DESCRIPTION OF THE PREFERRED EMBODIMENTS

In the following paragraphs, some preferred embodiments of the invention will be described by way of example and not limitation. It should be understood based on this disclosure that various other modifications can be made by those in the art based on these illustrated embodiments.

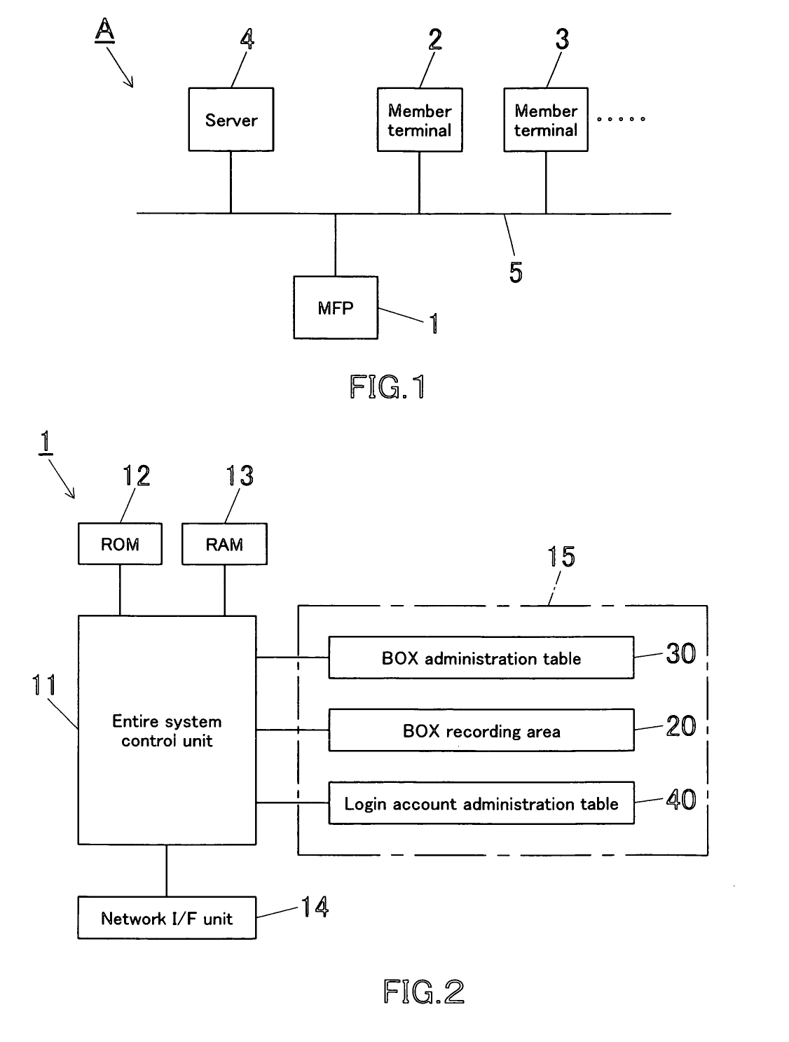

First, referring to FIG. 1, a configuration of a mail delivery system using an MFP that is an image processing apparatus in one embodiment of the present invention will be described.

In FIG. 1, the mail delivery system A comprises a MFP 1, member terminals 2, 3 and more member terminals respectively owned by individual users who are members of a mailing list, and a server 4. The MFP 1, the member terminals 2, 3 and other member terminals, and the server 4 are interconnected via a network 5.

The MFP 1 is a multifunctional digital image forming apparatus having a plurality of functions such as copying, printing, facsimile, scanning, as well as sending/receiving e-mails.

A personal computer (PC), for example, is used as the member terminal 2, 3 or other member terminal in the embodiment, but a PDA (Personal Digital Assistants), a cell phone, or the like may be also used.

The server 4 functions not only as a mail server, but also as a mailing list server for storing mailing lists.

Next, referring to FIG. 2, a functional configuration of the relevant part of the MFP 1 will be described.

As shown in FIG. 2, the MFP 1 comprises an entire system control unit 11, a ROM 12, a RAM 13, a network interface (I/F) unit 14, and a recording unit 15.

The entire system control unit 11 comprises a CPU, and has a plurality of more functions than controlling the entire process performed in the MFP 1. For example, the entire system control unit 11 judges whether or not an e-mail received via the network 5 is that is delivered according to a mailing list or that is forwarded after once delivered according to a mailing list; generates in the recording unit 15 a BOX associated with the mailing list and stores the e-mail (including both text and attached file) in said BOX if it is judged that the received e-mail is that is delivered according to a mailing list or that is forwarded after once delivered according to a mailing list. Here, a BOX is a recording area allowing classification and storage of documents.

In addition, the entire system control unit 11 acquires member information of a mailing list from the server 4,sets and eliminates an access permission to the BOX for each of the members in the mailing list, and requests the server 4 for adding the MFP 1 itself as a member of the mailing list.

The ROM 12 is a memory for storing a program to be executed by the CPU of the entire system control unit 11, and the RAM 13 is another memory used as a working area by the CPU of the entire system control unit 11.

The network I/F unit 14 has a function to communicate data with the member terminals 2 and 3 and the server 4 connected via the network 5, and thus, the user can communicate mails and display the files in the BOX on the display apparatuses in the member terminals 2 and 3 by a web browser via the network I/F unit 14.

The recording unit 15 is configured, for example, with a hard disk (HDD), and has a BOX recording area 20, a BOX administration table 30, and a login account administration table 40 as one of recording area.

The BOX recording area 20 is a recording area storing files such as documents (including images) in the form of BOX.

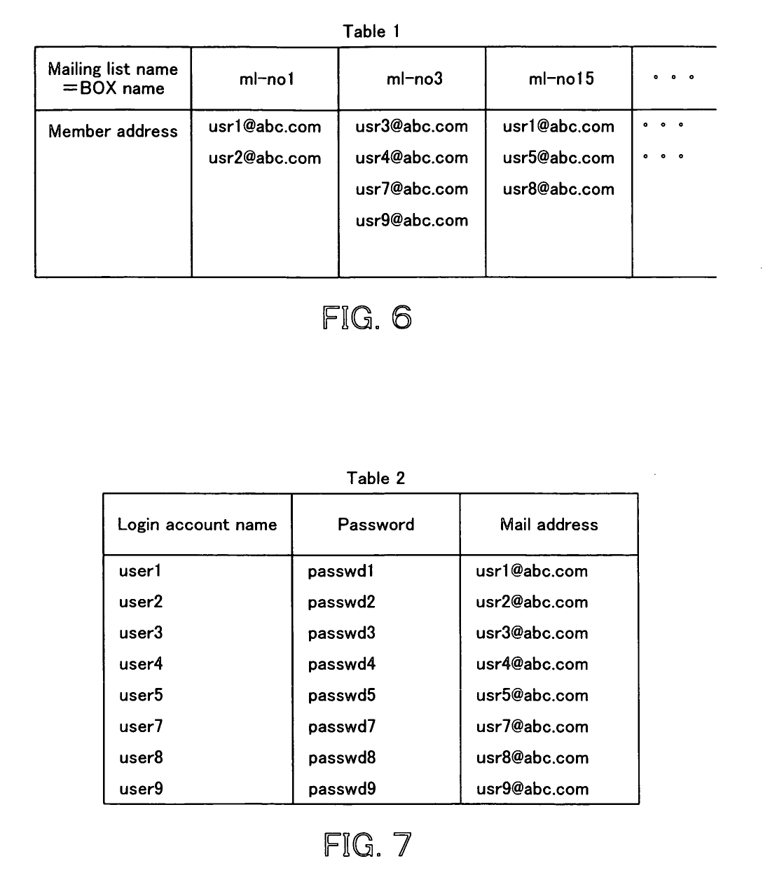

The BOX administration table 30 is a recording area for administrating the information about the BOX. As shown in Table 1 of FIG. 6, the BOX administration table 30 stores and administrates the corresponding relationship between each BOX having a designated mailing list name (“ml-no1”, “ml-no3”, or “ml-no15” in FIG. 6) and the mail addresses of the members who are allowed to access to each BOX (referred to also as member addresses). The member addresses in each BOX shown in Table 1 of FIG. 6 correspond to the member addresses in each mailing list.

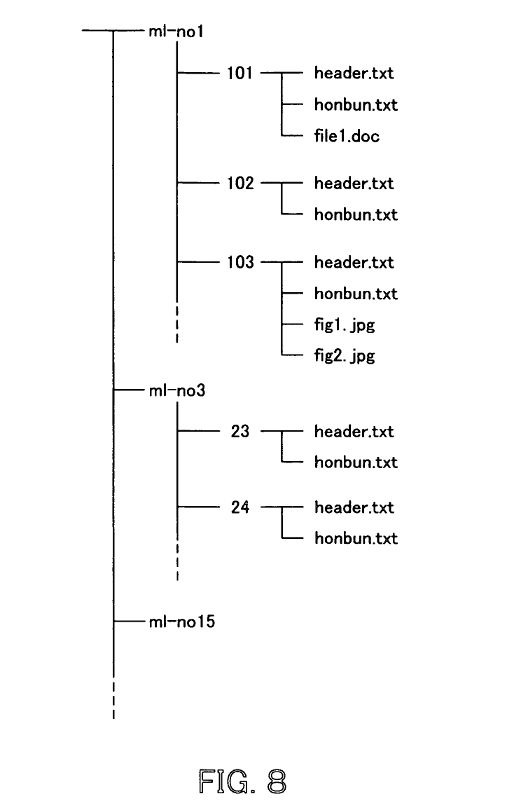

The login account administration table 40 is a recording area administrating the login account information for the members in the mailing list to login to the BOX generated as it is linked to the mailing list. As shown in Table 2 of FIG. 7. The login account is configured with login account name and a password and a mail address corresponding thereto.

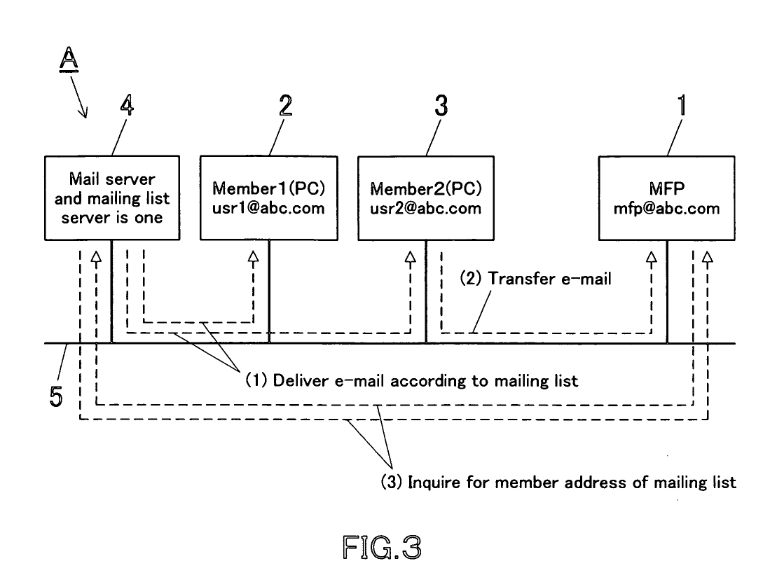

FIG. 3 is a drawing for description of the e-mail delivering operation in the e-mail delivering system A of FIG. 1.

In FIG. 3, an MFP 1, a server 4, and member terminals 2 and 3 respectively of the members 1 and 2 in the mailing list are connected to each other via a network 5.

The e-mail delivering operation is performed in the steps (1) to (3) shown in FIG. 3.

(1) The member terminals 2 and 3 receive an e-mail delivered according to the mailing list.

It is assumed here that an e-mail delivered to an mailing list “ml-no1@abc.com” in a mailing list named “ml-no1” (see Table 1 in FIG. 6) reaches a member 1 (mail address=usr1@abc.com) and a member 2 (mail address =usr2@abc.com), the members in the mailing list.

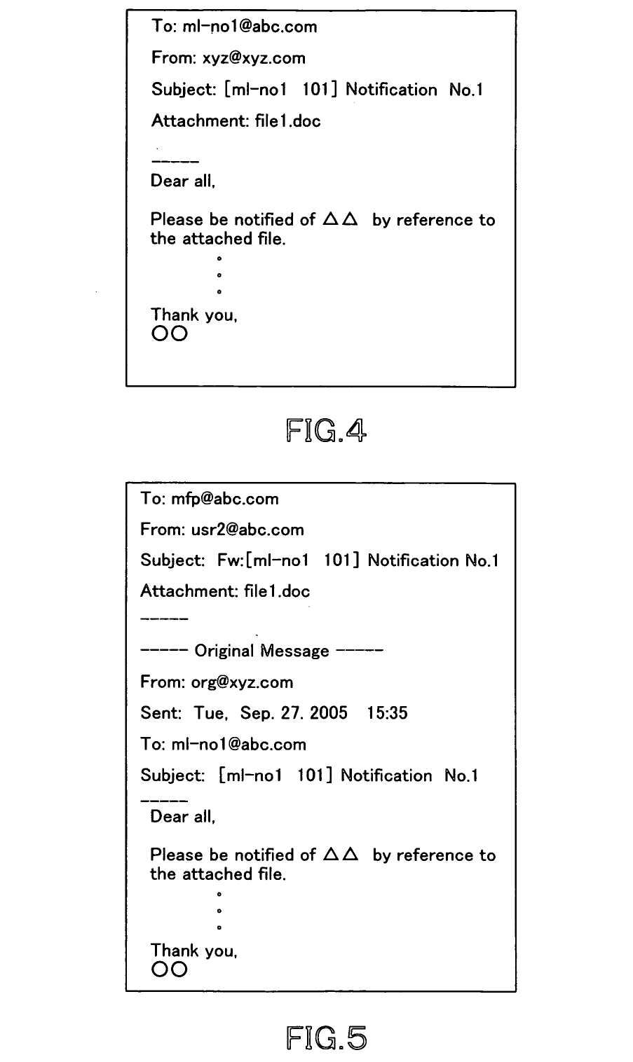

### An example of the description in the delivered e-mail is shown in FIG. 4. The server 4 attaches a prefix [#### ****] (wherein, #### represents a mailing list name, and **** represents a serial number) to the subject of the delivered mail. In the example of FIG. 4, a prefix [ml-no1 101] is attached.

(2) The member 2 forwards the received e-mail to the MFP 1 (mail address: mfp@abc.com).

An example of the description in the e-mail forwarded to the MFP 1 is shown in FIG. 5.

It is assumed that the text in the forwarded e-mail includes the original e-mail-destination information “To: ml-no1@abc.com” and sender information “From: orgaxyz.com” attached by the user's mailer software program.

The entire system controlling unit 11 of MFP 1 judges from the Subject “FW: [ml-no1 101]” in the transfer mail that it is a forwarded e-mail delivered elsewhere according to a mailing list, and retrieves whether there is a BOX named “ml-no1” showing the description of the BOX administration table 30 in Table 1 of FIG. 6. If there is no BOX named “ml-no1”, the entire system control unit 11 generates a now BOX named “ml-no1”.

Additionally, the entire system control unit 11 retrieves whether there is a folder named “101” in the BOX, and if there is the folder, it stores the e-mail in the same folder of the BOX. If there is no folder named “101”, it generates a folder according to its serial number and stores the e-mail therein. As shown in FIG. 8, each BOX is managed with folders.

The names of the BOX and the folder may be different respectively from the name of mailing list and the serial number, and may be the names associated with the mailing list and the serial number.

In FIG. 8, the header.txt represents a file storing the sender, the date and time of transmission, and the subject of e-mail; and the honbun.txt represents a file storing the text of e-mail. Other files (e.g., file1.doc) stored in the same folder are files attached to the e-mail.

(3) The MFP 1 inquires of the server 4 the members in the mailing list “ml-no1”.

If the members in the mailing list “ml-no1” are, for example, members having mail addresses of usr1@abc.com and usr2@abc.com, the information is transmitted from the server 4.

With this data, the MFP 1 establishes a setting allowing only members having mail addresses of usr1@abc.com and usr2@abc.com to access to the BOX “ml-no1”. Specifically, as shown in Table 1 of FIG. 6, it stores member addresses associated with BOX “ml-no1” in the BOX administration table 30 and generates a login account, if there is not the login account as will be described below. In this way, it allows new members to access to the BOX.

If member addresses other than those obtained from the mail server 4 are stored in the BOX “ml-no1” of the BOX administration table 30 as accessible member addresses, the MFP 1 prohibits access of the members in the mail server 4 by deleting the member addresses. In this way, members eliminated from the mailing list cannot access to the BOX contents, preventing undesirable leakage of information.

On the other hand, as described above, the login accounts (shown in Table 2 of FIG. 7) for the members to login the BOX are managed by the login account administration table 40. That is, mail addresses of the members in the mailing list are managed in the login account administration table 40.

If the mail address of a member in the mailing list is not present in the login account administration table 40, the MFP 1 generates a new login account, generates an account name and a password automatically, and notifies them to the mail address. If there is not the mail address (mfp@abc.com) of the MFP 1 itself in the mail addresses of the members in the mailing list, the MFP 1 can send a request to the server 4 for adding “mfp@abc.com” as a member of the mailing list “ml-no1”.

If an e-mail delivered is judge to be an e-mail delivered via the network 5 according to the mailing list or an e-mail forwarded from that delivered elsewhere according to the mailing list, the e-mail is stored in the BOX generated associated with the mailing list, and thus, even if a new member is added to the mailing list, the member can obtain the texts in the past e-mails and the description in the attached files thereto stored in the BOX.

In addition, because e-mail texts and attached files are stored cumulatively in the BOX generated associated with the mailing list, each member needs not store these e-mail texts and attached files in the recording unit of each member terminal 2 or 3, or the mail server 4, and thus, it is possible to avoid the inconvenience of the data occupying much of the memory capacity of the member terminals 2 and 3 or the mail server 4.

Further, because there is a setting allowing each member in the mailing list to access to the corresponding BOX, each user, a member in the mailing list, can access to the e-mail texts and attached files in the BOX anytime. When a new member is added to the mailing list, a setting allowing it to access to the corresponding BOX is established automatically, and the fact is notified to the new member. Thus, the new member recognizes that it can login to the BOX, and can login and access to the BOX without sending an irksome request for permission to access to the BOX to the MFP 1.

Hereinafter, operation when a member accesses to the MFP 1 to examine the BOX for a mailing list “ml-no1” will be described.

The MFP 1 has a function allowing the members in the mailing list to access to the BOX files via a web browser.

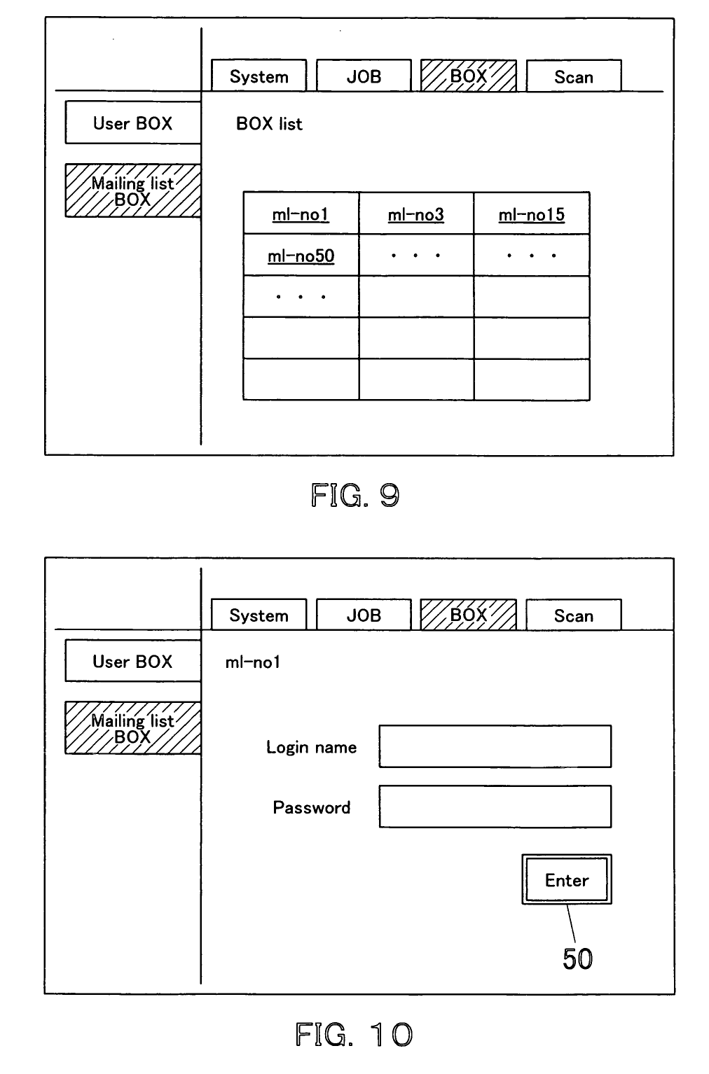

FIG. 9 shows a screen displaying a list of BOXes generated as associated with a mailing list (mailing list BOXes) in the MFP 1 by the web browser in a user terminal 2 or 3. In FIG. 9, the tab displayed in shade means that the tab is selected.

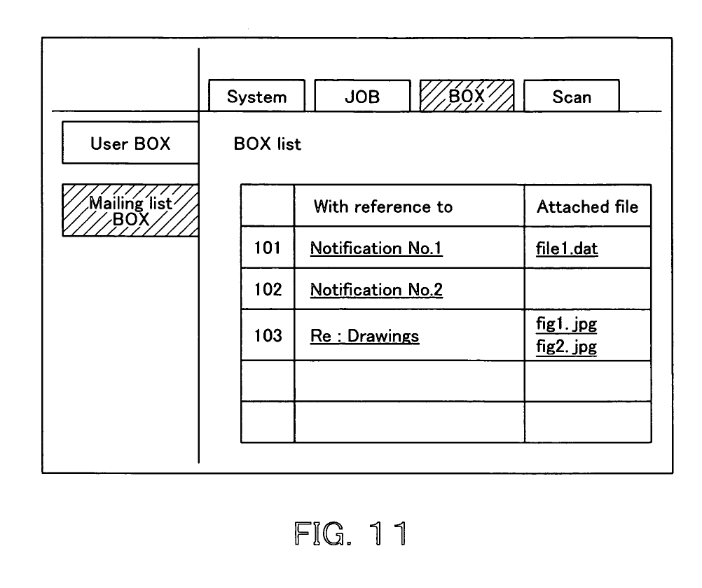

When a member clicks on a BOX name, for example “ml-no1”, the screen jumps to the login screen corresponding to the BOX “ml-no1” shown in FIG. 10. A login name (account name) and a password are to be inputted in the screen. When the member inputs the login name and the password and pushes the “Enter” button 50, the inputted login name and password are sent to the MFP 1.

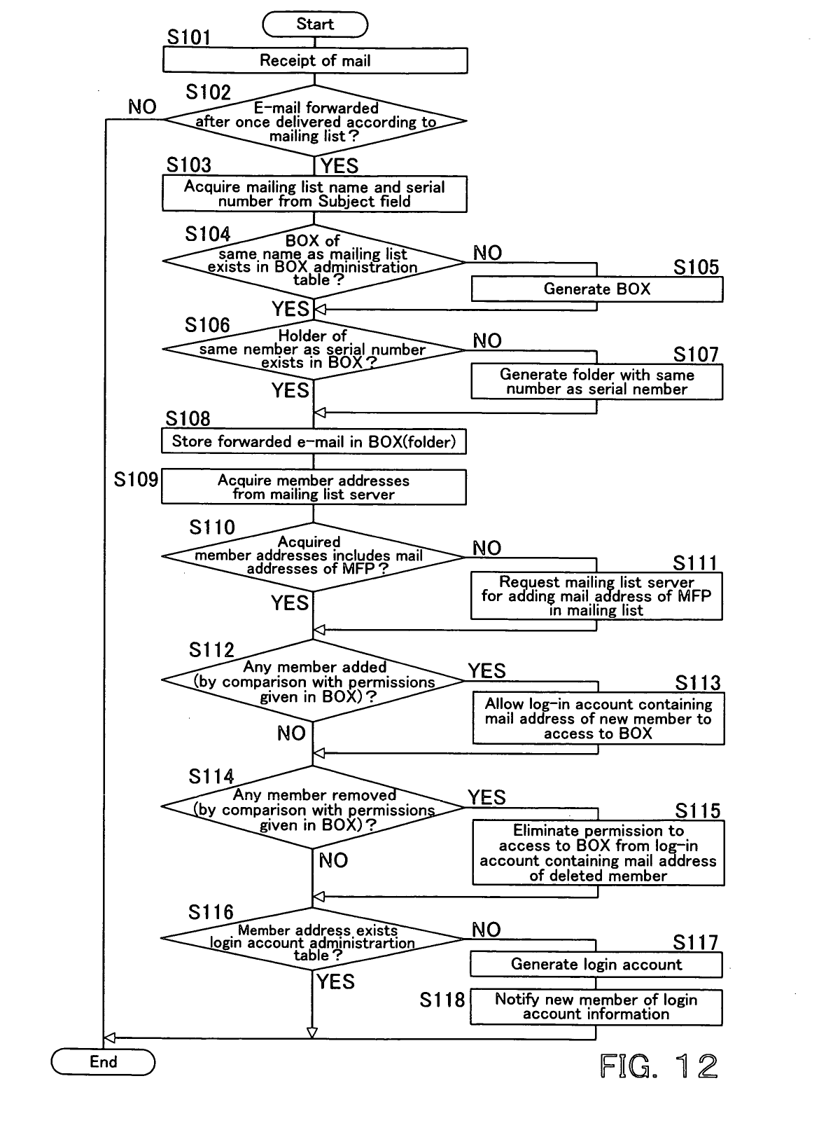

The entire system control unit 11 in MFP 1 examines whether the combination of the inputted login name and password is present in the login account administration table 40 (Table 2 of FIG. 7), and, if present, examines whether the mail address of the login account is present in the member addresses associated with the BOX named “ml-no1” in the BOX administration table 30 (Table 1 in FIG. 6), and, if present, displays a screen showing a list of descriptions in the BOX named “ml-no1” on the display apparatuses in the member terminal 2 or 3, as shown in FIG. 11.

If the combination of the inputted login name and password is not present in the login account administration table 40, or if the mail address of the login account is not present in the member addresses associated with the BOX named “ml-no1” in BOX administration table 30, the entire system control unit 11 in MFP 1 displays an error message indicating that access is prohibited on the display apparatus in the member terminal 2 or 3.

“101, 102, and others” on the screen in FIG. 11 are equivalent respectively to the **** regions in the prefix [#### ****] contained in the Subject of the e-mail. In FIG. 11, for example, the Subject of “101” is named “Notification No. 1”, and the attached file thereof is named “file1.dat”.

When a user clicks an item in the Subject or attached file columns, the file is displayed on the screen by browser or downloaded as a file into the member terminal 2 or 3. In this way, the member can browse the description.

Hereinafter, the processing executed in the MFP 1 when the MFP 1 receives an e-mail forwarded from a member, with reference to the flowchart shown in FIG. 12. The processing is executed by the entire system control unit (CPU) 11 of MFP 1 according to the operation program stored in the ROM 12.

When an e-mail is received in step S101 in FIG. 12, it is judged whether the mail is delivered according to the mailing list in step S102, and if it is not a mail delivered according to the mailing list (NO in step S102), the processing terminates as it is. If it is a mail delivered according to the mailing list (YES in step S102), a mailing list name and a serial number are acquired from the Subject of the e-mail in step S103, and the processing advances to step S104.

In step S104, it is judged whether the BOX having the obtained mailing list name is present in the BOX administration table 30, and, if it is present in the BOX administration table 30 (YES in step S104), the processing advances to step S106. If it is not in the BOX administration table 30 (NO in step S104), a BOX having the mailing list name is generated additionally in step S105, and the processing advances to step S106.

In step S106, it is judged whether there is a folder having the same serial number as that acquired in the BOX, and if the folder having the same serial number exists (YES in step S106), the processing advances to step S108. If the folder having the serial number is absent (NO in step S106), a folder corresponding to the serial number is generated in step S107, and the processing advances to step S108.

In step S108, the forwarded e-mail is stored in the folder in the BOX, and in step S109, the member addresses are acquired from the server 4.

Then in step S110, it is judged whether the mail address of MFP 1 itself is included in the acquired member addresses, and if the mail address of MFP 1 itself is included (YES in step 5110), the processing advances to step S112. If the mail address of MFP 1 itself is not included (NO in step S110), a message requesting the mail address of MFP 1 itself to be added and registered in the mailing list is sent to the server 4 in step 5111, and the processing advances to step S112. By the request, the MFP 1 itself is registered as a member in the mailing list corresponding to the server 4. Thus after registration, the MFP 1 can receive any e-mails sent according to mailing list.

In step S112, it is judged whether a new accessible member is added (whether there is a new member) by comparison with the current accessible members in the BOX shown in Table 1 of FIG. 6. If there is no need for adding a member (NO in step S112), the processing advances to step S114. If there is a need for adding a member (YES in step S112), the mail address of the new member is added to the corresponding BOX, and access permission is given to the login account having the mail address in step S113, and the processing advances to step S114.

In step S114, it is judged whether a member is deleted (where there is a member who is to be deleted from the mailing list) by comparison with the current accessible members in the BOX shown in Table 1 of FIG. 6. If there is no need for deleting a member (NO in step S114), the processing advances to step S116. If deletion of a member is needed (YES in step S114), the mail address of the member to be deleted is deleted, and the BOX access permission allocated to the login account having the mail address is eliminated in step S115, and the processing advances to step S116.

In step S116, it is judged whether the mail address of a new member in the step S113 is present in the login account administration table (shown in FIG. 7 Table 2), and if the mail address is present (YES in step S116), the processing terminates as it is. If the mail address is absent (NO in step S116), a login account is generated in step S117, the fact is informed to the new member corresponding to the generated login account, and the processing terminates in step S118,

In the embodiments above, described is a case where acquisition of the member information in the mailing list from the server 4 and setting for allowing access to the BOX by the MFP 1 are performed when an e-mail from member is delivered to the MFP 1, but the operations may be performed periodically or only when a member accesses thereto.

In addition, although a case where the MFP 1 receives a mail forwarded from the members in the mailing list is described in the embodiments above, the MFP 1 can receive directly a mail delivered according to the mailing list if the MFP 1 is included in the members in the mailing list. In such a case, the mail obtained contains a description similar to that shown in FIG. 4, and the e-mail is stored in the folder of the corresponding BOX or a newly generated BOX or folder if the corresponding BOX or folder is absent, according to the e-mail-destination information “To: ml-no1@abc.com” and the Subject “[ml-no1 101]”.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. An image processing apparatus comprising:
a judgment unit for judging whether or not an e-mail received via a network is an e-mail delivered according to a mailing list or an e-mail forwarded after once delivered according to a mailing list;
a recording unit; and
a control unit for generating a BOX storing the e-mail as associated with the mailing list in said recording unit and storing the e-mail in said BOX if the received e-mail is judged to be an e-mail delivered according to a mailing list or an e-mail forwarded after once delivered according to a mailing list by said judgment unit.

2. The image processing apparatus as recited in claim 1, wherein said control unit stores the received e-mail in an existing BOX associated with the mailing list without generating a new BOX, if there exists the BOX.

3. The image processing apparatus as recited in claim 1, wherein said control unit acquires member information of the mailing list from a mailing list server on the network and performs the settings allowing the members in the mailing list to access to the BOX based on the acquired member information.

4. The image processing apparatus as recited in claim 3, wherein said control unit judges based on said acquired member information of the mailing list whether or not there is any member change in the mailing list, performs the settings allowing the member to access to the BOX if there is an added member, and cancels the settings allowing the member to access to the BOX if there is a deleted member.

5. The image processing apparatus as recited in claim 3, wherein, if the setting allowing a member in the mailing list to access to the BOX is performed, said control unit notifies the fact to the member.

6. The image processing apparatus as recited in claim 3, wherein said control unit acquires member information of the mailing list from said mailing list server at least either when an e-mail is received or when a member accesses thereto.

7. The image processing apparatus as recited in claim 3, wherein said control unit acquires member information of the mailing list periodically from said mailing list server.

8. The image processing apparatus as recited in claim 1, wherein said control unit acquires the member information of the mailing list from said mailing list server on the network, and, if the image processing apparatus itself is not included in the members of the acquired mailing list, requests the mailing list server to add itself to the members of the mailing list.

9. A mail processing method for an image processing apparatus capable of receiving e-mails, comprising the steps of:
judging whether or not an e-mail received via a network is an e-mail delivered according to a mailing list or an e-mail forwarded after once delivered according to a mailing list;
generating a BOX storing the e-mail as associated with the mailing list in a recording unit if the received e-mail is judged to be an e-mail delivered according to a mailing list or an e-mail forwarded after once delivered according to a mailing list in the judgment step; and
storing the e-mail in the generated BOX.

10. The mail processing method as recited in claim 9, wherein, if there exists a BOX associated with the mailing list, the received e-mail is stored in the existing BOX without generating a new BOX.

11. The mail processing method as recited in claim 9, further comprising the steps of acquiring member information of the mailing list from a mailing list server on the network and performing the settings allowing the members in the mailing list to access to the BOX based on the acquired member information.

12. The mail processing method as recited in claim 11, wherein it is judged based on said acquired member information of the mailing list whether or not there is any member change in the mailing list, if there is an added member, the settings allowing the member to access to the BOX is performed, and if there is a deleted member, the settings allowing the member to access to the BOX is canceled.

13. The mail processing method as recited in claim 11, wherein, if the setting allowing a member in the mailing list to access to the BOX is performed, the fact is notified to the member.

14. The mail processing method as recited in claim 9, further comprising the step of acquiring the member information of the mailing list from said mailing list server on the network, and, requesting the mailing list server to add itself to the members of the mailing list if the image processing apparatus itself is not included in the members of the acquired mailing list.

15. A mail processing program stored on computer readable medium for making a computer in an image processing apparatus capable of receiving e-mails execute mail processing, comprising the steps of:
judging whether or not an e-mail received via a network is an e-mail delivered according to a mailing list or an e-mail forwarded after once delivered according to a mailing list;
generating a BOX storing the e-mail as associated with the mailing list in a recording unit if the received e-mail is judged to be an e-mail delivered according to a mailing list or an e-mail forwarded after once delivered according to a mailing list in the judgment step; and
storing the e-mail in the generated BOX.

16. The mail processing program as recited in claim 15, making the computer execute a processing of storing the received e-mail in the existing BOX associated with the mailing list without generating a new BOX if it exists.

17. The mail processing program as recited in claim 15, further making the computer execute the steps of acquiring member information of the mailing list from a mailing list server on the network and performing the settings allowing the members in the mailing list to access to the BOX based on the acquired member information.

18. The mail processing program are recited in claim 17, making the computer execute a processing of judging based on said acquired member information of the mailing list whether or not there is any member change in the mailing list, if there is an added member, performing the settings allowing the member to access to the BOX, and if there is a deleted member, canceling the settings allowing the member to access to the BOX.

19. The mail processing program as recited in claim 17, making the computer execute, if the setting allowing a member in the mailing list to access to the BOX is performed, a processing of notifying the fact to the member.

20. The mail processing program as recited in claim 15, making the computer execute the step of acquiring the member information of the mailing list from said mailing list server on the network, and, requesting the mailing list server to add itself to the members of the mailing list if the image processing apparatus itself is not included in the members of the acquired mailing list.
